(19) United States
(12) Patent Application Publication
(10) Pub. No.: US 2024/0359545 A1
(43) Pub. Date: Oct. 31, 2024

(54) Hardtop Slider Device

(71) Applicant: Brian Goldwitz, WATERBURY, CT (US)

(72) Inventor: Brian Goldwitz, WATERBURY, CT (US)

(21) Appl. No.: 18/649,535

(22) Filed: Apr. 29, 2024

Related U.S. Application Data
(60) Provisional application No. 63/462,979, filed on Apr. 29, 2023.

(51) Int. Cl. B60J 7/20; B60J 7/16

(52) U.S. Cl. CPC B60J 7/201; B60J 7/1642

(57) ABSTRACT

The current invention is a double hard top hinge and System. It allows for the easy of moving sliding and storing a hard top on a vehicle like an SUV or a Jeep®. The system will have a double hinge that will allow the roof panel to be moved on top of a accessory such as a luggage rack this is on top of a vehicle. The panels can be stacked and stored at the same level as the top of the cab.

### RELATED APPLICATIONS

It is a non-provisional of provisional application 63/462,979 filed Apr. 29, 2023, and claims its priority date.

### TECHNICAL FIELD

The technology discussed below relates to an on-vehicle hardtop panel storage and more particularly one stores on a roof rack.

### BACKGROUND

People with SUV and jeeps sometimes need a quick and easy place to store a removed panel of their hardtop that is located on their vehicle. This will allow a quick and easy method to reinstall the hardtop panel.

There currently no method for the easy storage of a hard top panel for SUVs that works well, and is moved and stored easily and efficiently were a vehicle has an accessory such as a luggage rack or similar device.

There is still room for improvement in the art.

### SUMMARY

The current invention is a double hard top hinge and System. It allows for the easy of moving sliding and storing a hard top on a vehicle like an SUV or a Jeep®. The system will have a double hinge that will allow the roof panel to be moved on top of an accessory such as a luggage rack that is on top of a vehicle. The panels can be stacked and stored at the same level as the top of the cab.

These are improvements over the current art.

### DRAWINGS

FIG. 1 show the double hinge positioned on the top of the vehicle on a luggage rack;

FIG. 2 shows the double hinge connected to the roof panels;

FIG. 3 shows the roof panels being moved up on the luggage rack;

FIG. 4 shows the roof panels being stored on the luggage rack;

FIG. 5 shows the roof panels on the top of the vehicle;

FIG. 6 shows the double hinge holding the roof panels on the luggage rack;

FIG. 7 is a front view of the roof panels being stored;

FIG. 8 shows double hinge being used;

FIG. 9 shows the inside view of the double hinge;

FIG. 10 shows the roof panels being strapped down;

FIG. 11 shows a latching system for the roof panels;

FIG. 12 shows the roof panels;

FIG. 13 shows the roof panels on the luggage rack;

FIG. 14 shows the double hinge and locking mechanism;

FIG. 15 shows the roof panels being stored;

FIG. 16 shows a top view; and

FIG. 17 shows the double hinge and its base.

### DETAILED DESCRIPTION

The illustrations presented herein are, in some instances, not actual views of any particular framing devices or components thereof but may be idealized representations which are employed to describe the present disclosure. Additionally, elements common between figures may retain the same numerical designation.

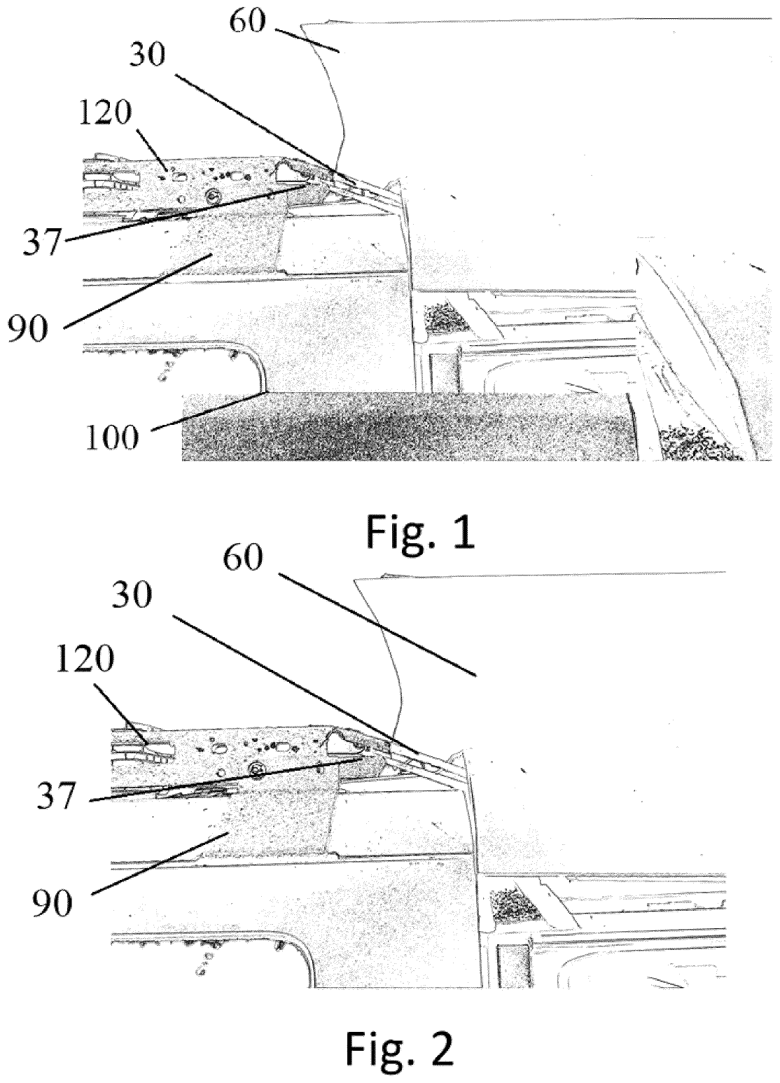

The current invention, as shown in FIGS. 1 through 17, is a double hard top hinge 30 and System. It allows for the easy of moving sliding and storing hard top panels 60 on a vehicle 100 like an SUV or a Jeep®. The system will have a double hinge 30 that will allow one or more roof panels 60 to be moved on top of an accessory such as a luggage rack 120 on the top of a vehicle 100. The panels 60 can be stacked and stored at the same level as the top of the cab.

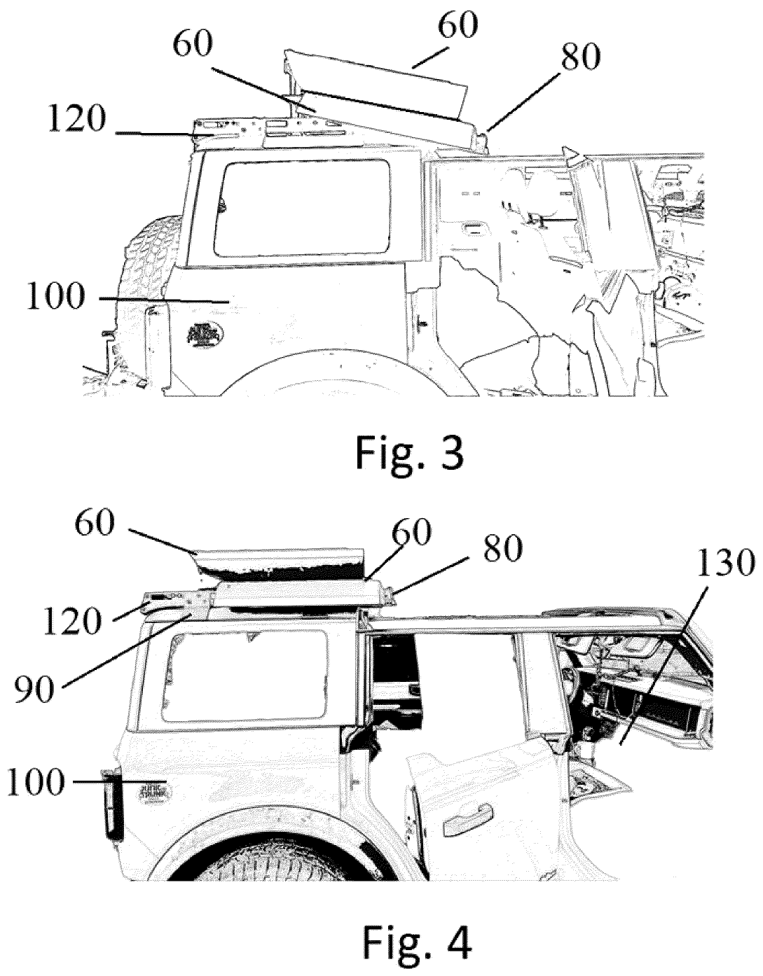

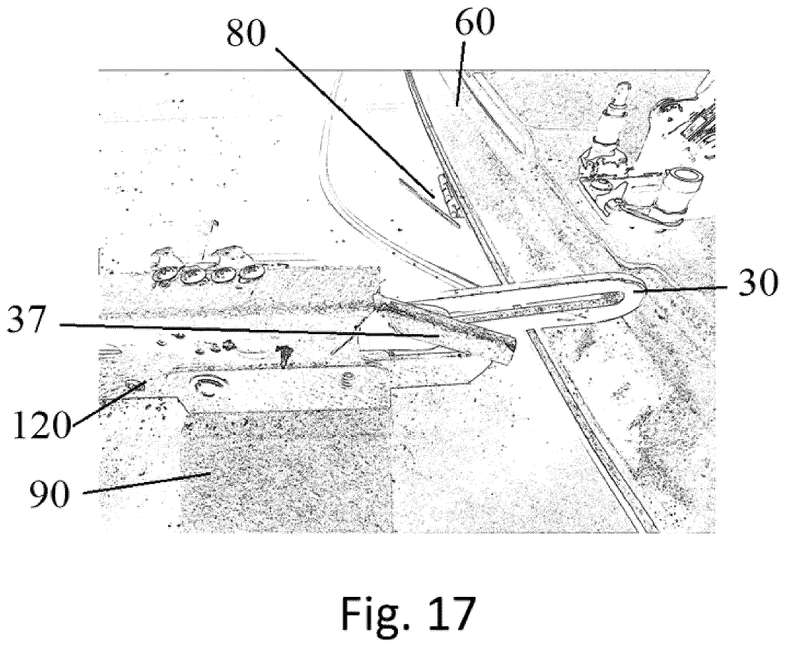

FIG. 1 shows the double hinge 30 positioned on the top back of vehicle 100. The double hinge 30 is a flat rectangular shaped bar with rounded end edges with a sliding slot opening in the center that runs the length of the double hinge 30. It is attached to the roof with a double hinge attachment. The double hinge attachment is connected to the roof luggage rack 120 using a base 37 and has a sliding bolt 35 that is in the sliding slot and attached to one or more of the panels 60 allowing the panel 60 to be slid on the double hinge 30 backward into a storage and forward for use of as a roof panel on the top of the cab 130. The double hinge 30 slides on the sliding bolt 35. FIGS. 1 and 2 shows a roof panel 60 sliding toward the luggage rack 120 on the double hinge 80. FIG. 17 shows the double hinge 30 and its base 37. FIG. 3 shows the roof panels 60 stacked with one panel 60 and top of the other connected by a plurality of hinges 80 being moved up on the luggage rack 120 using the double hinge 30 away from the cab 130. FIG. 4 shows the roof panels 60 being moved further back on the luggage rack 120 into the final storage position. The luggage rack 120 is attached to the vehicle 100 using an attachment means 90. The double hinge 30 system could be used with other vehicle accessories such as a bike rack, luggage rack or even the roof. The base 37 is attached to and at the front of the luggage rack 120 allowing the double hinge 30 to be used to move the panels 60 for storage on the luggage rack 120.

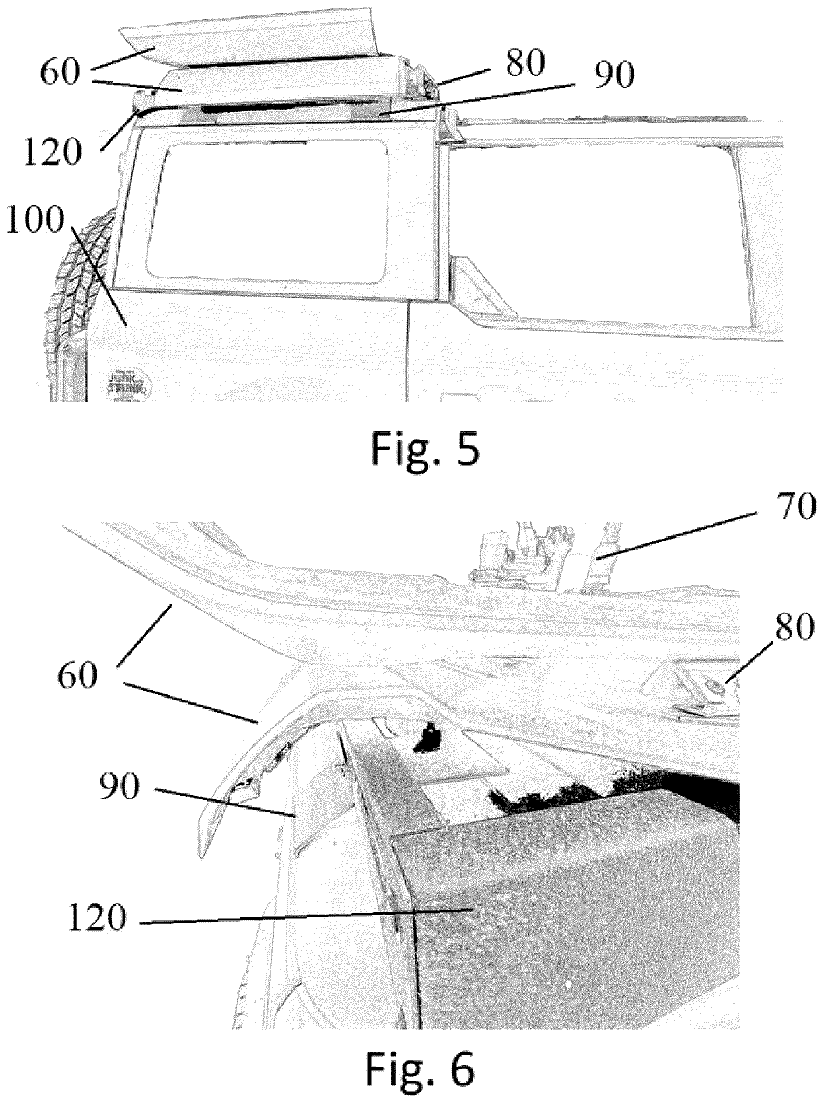

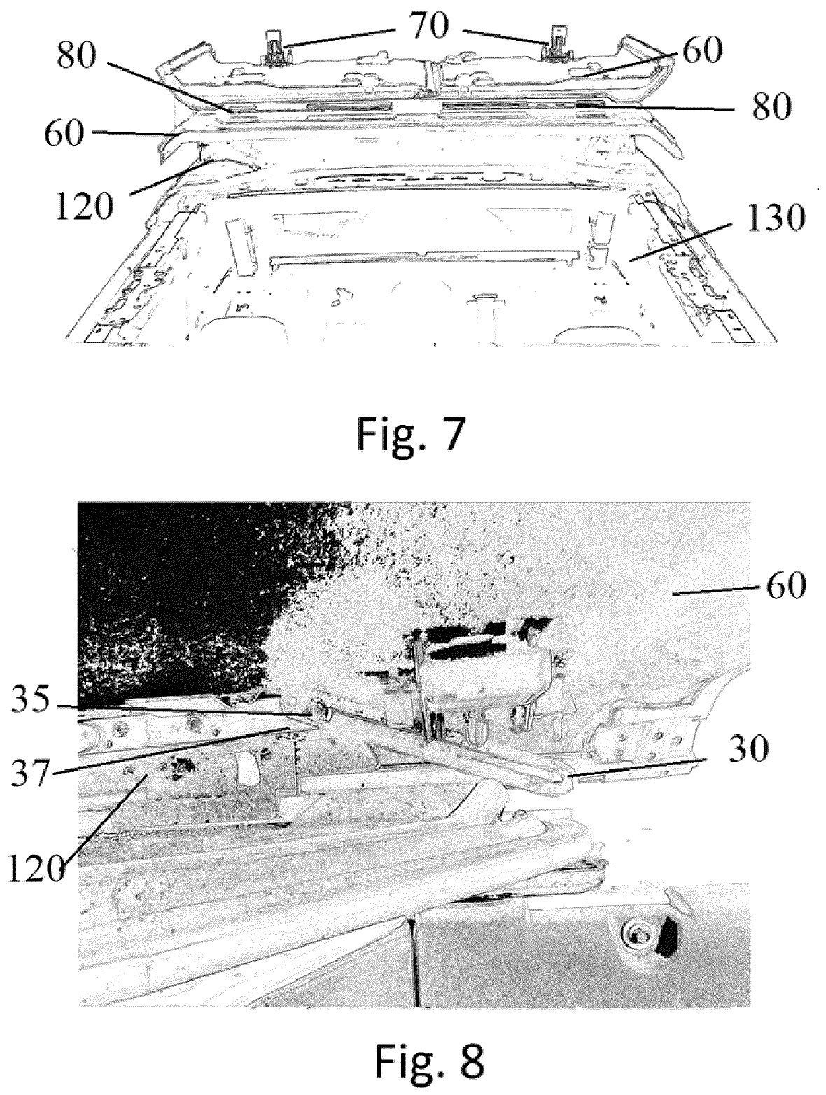

FIG. 5 shows the roof panels 60 being stored on the top of the vehicle 100 on a luggage rack 120 in its final position. FIG. 6 shows the roof panels 60 in a storage position on the luggage rack 120 where the double hinge 30 is flush with the side of the luggage rack 120. While FIG. 7 is a front view of the roof panels 60 being stored. FIG. 7 shows the latches 70 holding the panels 60 in place and the hinges 80 connecting the two panels 60.

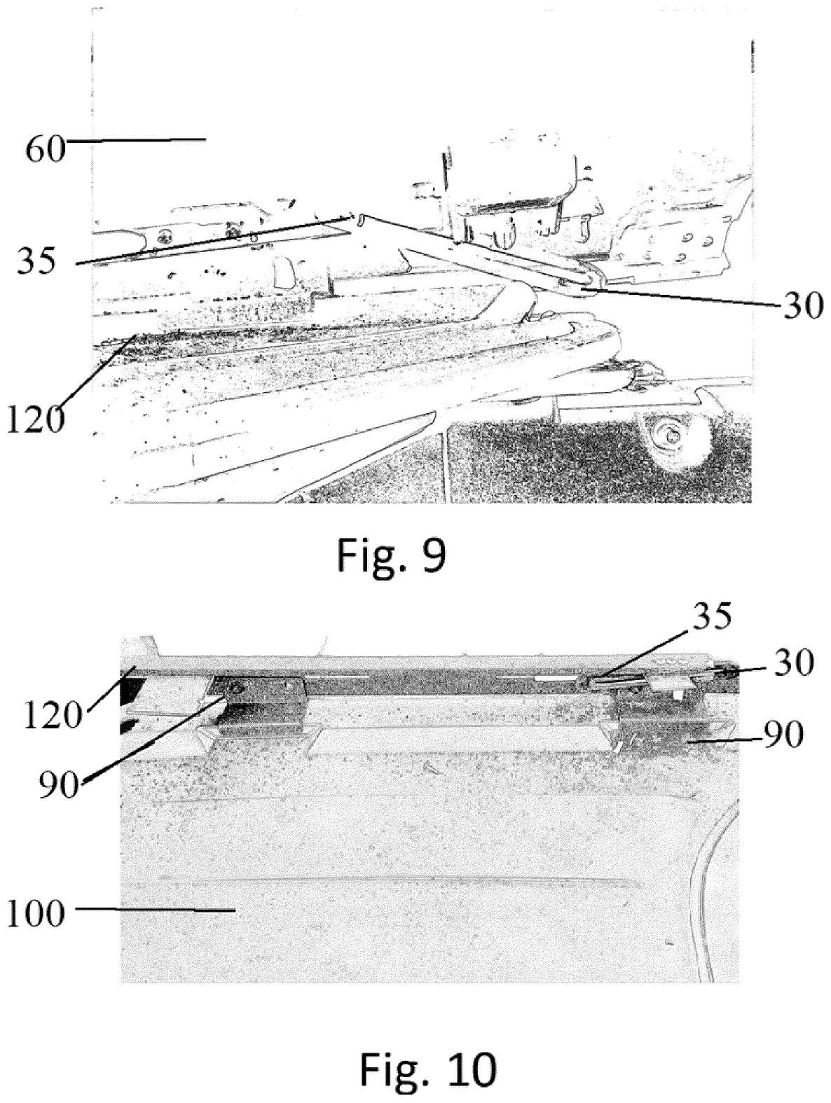

FIG. 8 shows double hinge 30 using the sliding bolt 35 being used to move the roof panels 60 onto the luggage rack 120 for storage. FIG. 9 shows the roof panels 60 being moved further up towards the luggage rack 120 on the double hinge 30.

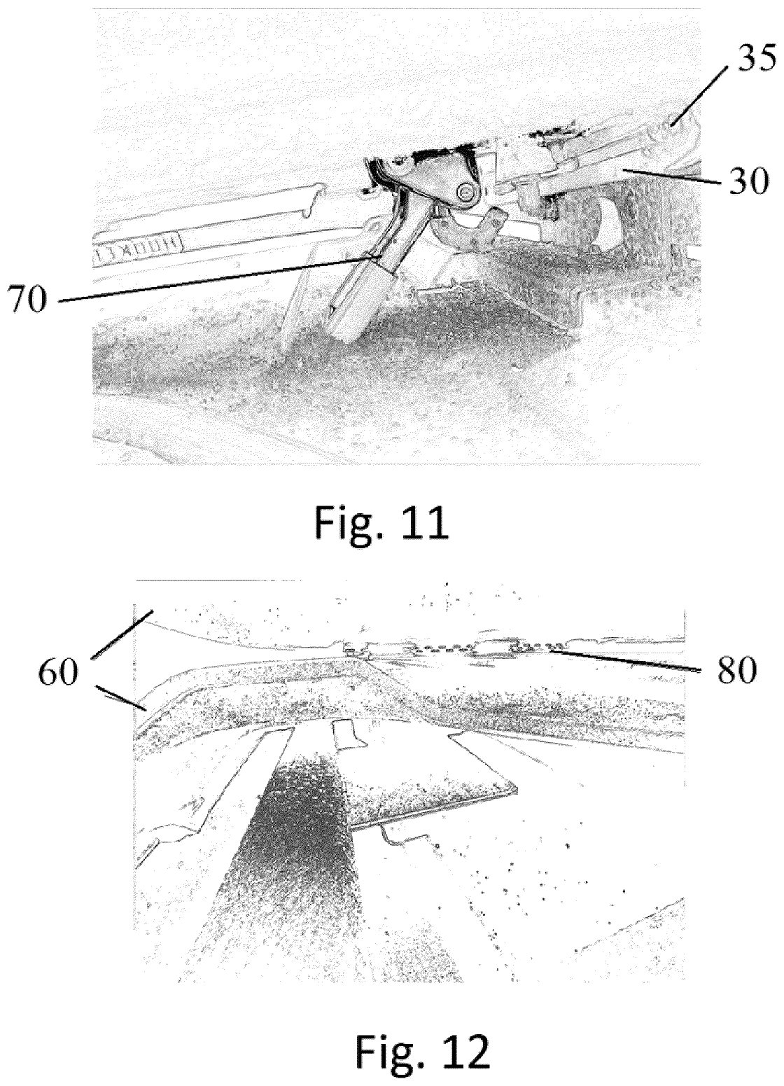

FIG. 10 shows a side view of the luggage rack and the double hinge 30. FIG. 11 a latching system 70 for the roof panels 60 with the base 37, the sliding bolt 35 and the double hinge 30 in a closed position. The handle is moved up and the latch has a hook that moves up to hold the panels in place. FIG. 14 shows the hinge 80 and locking mechanism 70.

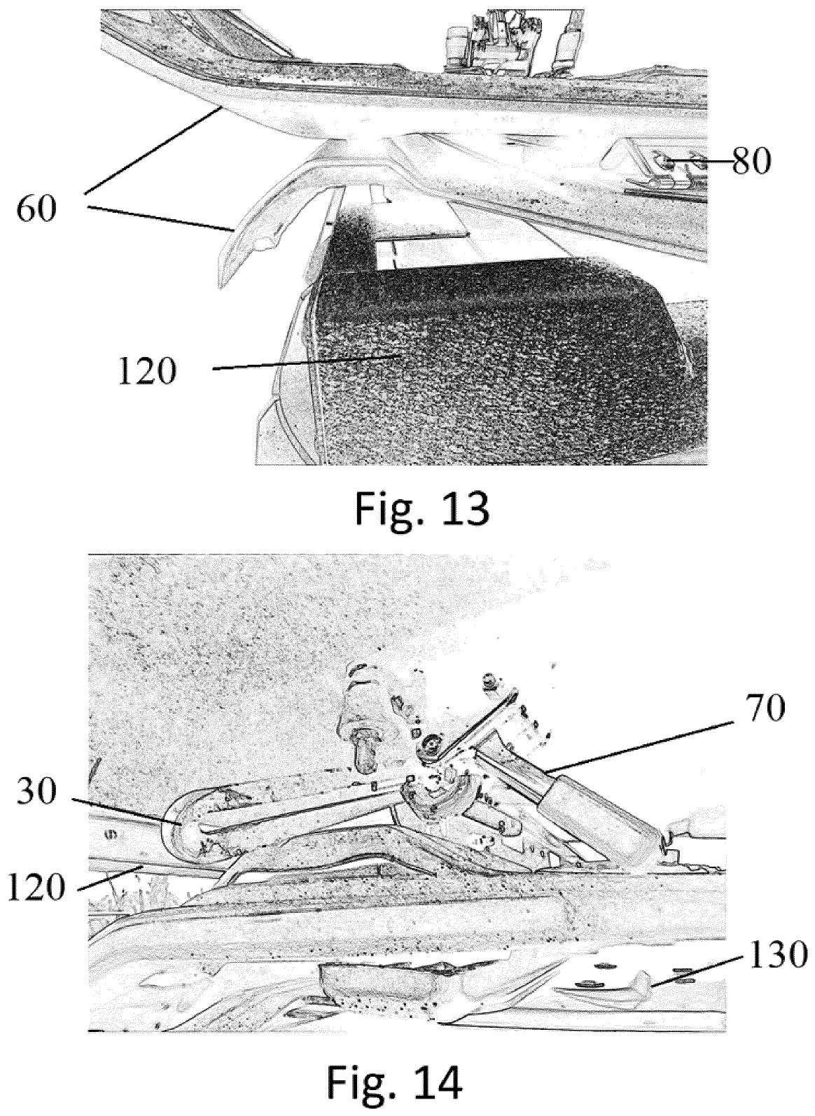

FIG. 12 shows the roof panels 60 connected by the hinge 80. FIG. 13 shows the roof panels 60 on the luggage rack 120.

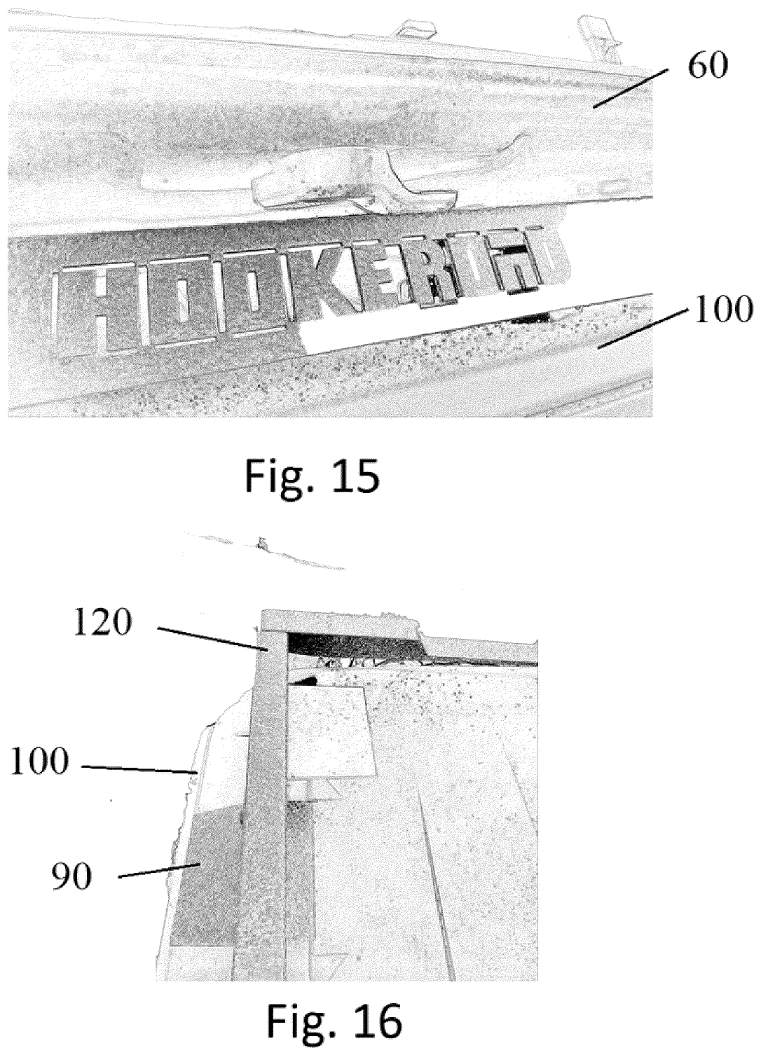

FIG. 15 shows the roof panels 60 being stored. FIG. 16 shows a top view of the luggage rack 120.

FIG. 17 shows the double hinge 30 connected to the luggage rack 120 through the base 37 and extended to connect to one of the panels 60. The connected panel 60 uses the a sliding bolt 35 to leverage its movement to be pushed back into a storage position or in the position to cover the cab 130,

In an alternative, the double hinge 30 can be used to attach the roof panels 60 to other accessories beside just a roof rack 120.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device to assist with the storage of roof panels comprising:
a double hinge which is flat rectangular shaped bar with rounded end edges with a sliding slot opening in the center that runs the length of the double hinge.

2. A device to assist with the storage of roof panel according to claim 1 comprising:
a double hinge is attached to a vehicle using a double hinge attachment.

3. A device to assist with the storage of roof panel according to claim 1 comprising:
a double hinge is attached to a roof top accessory using a double hinge attachment.

4. A device to assist with the storage of roof panel according to claim 3 comprising:
where the roof top accessory is a luggage rack.

5. A device to assist with the storage of roof panel according to claim 1 comprising:
having a sliding bolt attached to a panel and positioned in the sliding slot of the double hinge.

6. A device to assist with the storage of roof panel according to claim 5 comprising:
where the double hinge slides on the sliding bolt.

7. A device to assist with the storage of roof panel according to claim 5 comprising:
having a plurality of panels connected by a hinge.

8. A device to assist with the storage of roof panel according to claim 5 comprising:
having the panel moved forward and backward using the double hinge.

9. A device to assist with the storage of roof panel according to claim 7 comprising:
having the panels stored with one panel on the top of another panel.

10. A device to assist with the storage of roof panel according to claim 5 comprising:
having latches that hold the panels in place.

11. A system to assist with the storage of roof panels comprising:
a double hinge which is flat rectangular shaped bar with rounded end edges with a sliding slot opening in the center that runs the length of the double hinge.

12. A system to assist with the storage of roof panel according to claim 11 comprising:
a double hinge is attached to a vehicle using a double hinge attachment.

13. A system to assist with the storage of roof panel according to claim 11 comprising:
a double hinge is attached to a roof top accessory using a double hinge attachment.

14. A system to assist with the storage of roof panel according to claim 13 comprising:
where the roof top accessory is a luggage rack.

15. A system to assist with the storage of roof panel according to claim 11 comprising:
having a sliding bolt attached to a panel and positioned in the sliding slot of the double hinge.

16. A system to assist with the storage of roof panel according to claim 15 comprising:
where the double hinge slides on the sliding bolt.

17. A system to assist with the storage of roof panel according to claim 15 comprising:
having a plurality of panels connected by a hinge.

18. A system to assist with the storage of roof panel according to claim 15 comprising:
having the panel moved forward and backward using the double hinge.

19. A system to assist with the storage of roof panel according to claim 17 comprising:
having the panels stored with one panel on the top of another panel.

20. A system to assist with the storage of roof panel according to claim 15 comprising:
having latches that hold the panels in place.
